(19) United States
(12) Patent Application Publication
(10) Pub. No.: US 2014/0188998 A1
(43) Pub. Date: Jul. 3, 2014

(54) METHODS, SYSTEMS, AND DEVICES FOR PROVIDING VEHICLE LIFECYCLE MESSAGES TO A MOBILE COMPUTING DEVICE

(71) Applicants: Tom Leonard, Jacksonville, FL (US); Aasif Bagdadi, Jacksonville, FL (US)

(72) Inventors: Tom Leonard, Jacksonville, FL (US); Aasif Bagdadi, Jacksonville, FL (US)

(73) Assignee: DMEAUTOMOTIVE, DAYTONA BEACH, FL (US)

(21) Appl. No.: 13/733,013

(22) Filed: Jan. 2, 2013

(51) Int. Cl. H04L 12/58

(52) U.S. Cl. CPC H04L 51/00
USPC 709/204

(57) ABSTRACT

Methods, systems, and devices for providing vehicle lifecycle messages are disclosed herein. A system for providing vehicle lifecycle messages includes an identification module, a linking module, and a lifecycle messaging module. The identification module receives vehicle identification information from a mobile computing device. The vehicle identification information uniquely identifies a vehicle. The linking module links the mobile computing device to a vehicle service account based on the vehicle identification information. The lifecycle messaging module provides lifecycle messages to the mobile computing device. The lifecycle messages based on a lifecycle stage of the vehicle.

### TECHNICAL FIELD

The present disclosure relates to lifecycle messaging for a vehicle and more particularly relates to providing vehicle lifecycle messaging to a mobile computing device.

### BRIEF DESCRIPTION OF THE DRAWINGS

FIG. 1 is a schematic diagram of a system for providing vehicle lifecycle messages to a mobile computing device consistent with embodiments disclosed herein.

FIG. 2 is a schematic block diagram of a messaging management system consistent with embodiments disclosed herein.

FIG. 3 shows schematic block diagrams of an example of a vehicle service account and a user account consistent with embodiments disclosed herein.

FIG. 4 is a schematic block diagram of a mobile lifecycle module of a mobile computing device consistent with embodiments disclosed herein.

FIG. 5 illustrates a screen shot of a login interface consistent with embodiments disclosed herein.

FIG. 6 illustrates a screen shot of a create account interface consistent with embodiments disclosed herein.

FIG. 7 illustrates a screen shot of a store locator interface for locating a preferred store consistent with embodiments disclosed herein.

FIG. 8 illustrates a screen shot of another store locator interface for locating a preferred store consistent with embodiments disclosed herein.

FIG. 9 illustrates a screen shot of a my account interface consistent with embodiments disclosed herein.

FIG. 10 illustrates a screen shot of a home screen interface consistent with embodiments disclosed herein.

FIG. 11 illustrates a screen shot of a my cars interface consistent with embodiments disclosed herein.

FIG. 12 illustrates a screen shot of a car details interface consistent with embodiments disclosed herein.

FIGS. 13A, 13B, 13C and 13D illustrate screen shots of an interface for obtaining vehicle identification information consistent with embodiments disclosed herein.

FIG. 14 illustrates a screen shot of a an example service history interface consistent with embodiments disclosed herein.

FIG. 15 illustrates a screen shot of a service details interface consistent with embodiments disclosed herein.

FIG. 16 illustrates a screen shot of a service reminder interface consistent with embodiments disclosed herein.

FIG. 17 illustrates a screen shot of a special offers interface consistent with embodiments disclosed herein.

FIGS. 18, 19, and 20 illustrate a screen shots of lifecycle messages consistent with embodiments disclosed herein.

FIG. 21 is a schematic flow chart diagram illustrating a method for sending vehicle lifecycle messages to a mobile computing device consistent with embodiments disclosed herein.

FIG. 22 is a schematic flow chart diagram illustrating a method for receiving lifecycle messages for a vehicle on a mobile computing device consistent with embodiments disclosed herein.

### DETAILED DESCRIPTION OF PREFERRED EMBODIMENTS

The advent of smart phones and other powerful mobile computing devices has led to phenomenal growth in the mobile computing industry. Mobile computing devices are capable of providing valuable services to users due to their portability and powerful computing capabilities. Often, mobile computing devices are carried by an owner almost everywhere the owner goes. This in turn provides considerable value not only in allowing the user to have powerful communications and computing tools almost always at the user's finger tips, but also to allow businesses to provide increasingly useful services and targeted marketing.

One class of businesses which can benefit greatly from the use of mobile applications are car dealerships, part stores, service centers or other automobile related businesses. For example, automobile dealerships are extremely competitive businesses where increasing the quality of services to buyers and potential buyers can translate into increased sales and profitability. In fact, one of the largest challenges with automotive dealerships is maintaining previous customers and/or getting new customers. Because mobile computing devices give a very direct channel of marketing and service to customers, dealerships may benefit greatly from providing useful and powerful mobile applications that keep customers and potential customers in touch with a dealership.

However, costs for developing, maintaining, and supporting a mobile application can be prohibitive to many businesses. In fact, even very large dealerships with multiple rooftop locations may not be able to justify the upfront or maintenance costs for a mobile application. Thus, many automotive related businesses are left out of the potentially lucrative mobile application arena.

In addition, existing mobile applications fail to provide the convenience and functionality to customers that will cause the mobile application to be installed, frequently used, and maintained on a mobile computing device. For example, existing mobile computing devices fail to link a mobile computing device to existing service accounts. Thus, resulting lifecycle messages are not as useful because they are based on incomplete information or else user's are left to manually enter performed vehicle service or other details that make an application tedious to use. Additionally, if service reminders are provided, users are generally required to specifically access a web link through a browser in order to know of their receipt and/or access them.

In view of the foregoing, the applicants have recognized that a need exists for a convenient and functionally powerful mobile application that connects car dealerships, parts stores, service centers and/or other automotive related business with existing and potential customers through a mobile computing device.

The present disclosure sets forth various systems, apparatuses, and methods for providing vehicle lifecycle messages to a mobile computing device. In one embodiment, a system for providing vehicle lifecycle messages includes an identification module, a linking module, and a lifecycle messaging module. The identification module receives vehicle identification information from a mobile computing device. The vehicle identification information uniquely identifies a vehicle. The linking module links the mobile computing device to a vehicle service account based on the vehicle identification information. The lifecycle messaging module provides lifecycle messages to the mobile computing device. In one embodiment, the lifecycle messages are based on a lifecycle stage of the vehicle. In another embodiment, the lifecycle messages are based on one or more lifecycle details of the vehicle.

A detailed description of systems and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

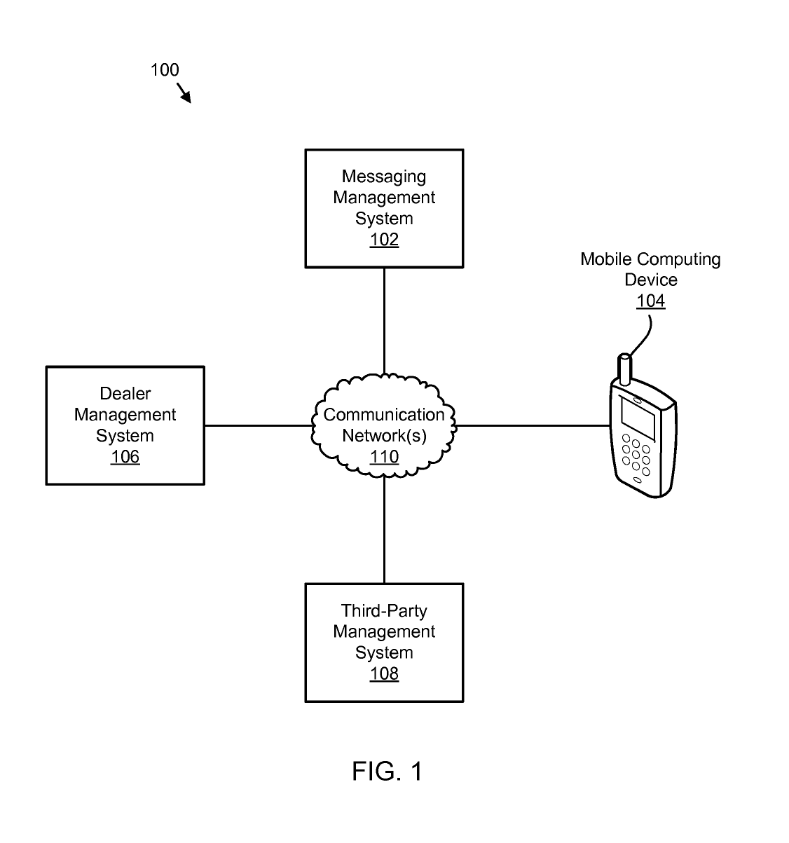

FIG. 1 is a schematic diagram of an example system 100 for providing vehicle lifecycle messages to a mobile computing device 104. The system 100 includes a messaging management system 102, a mobile computing device 104, a dealer management system 106, a third party management system 108, and a communications network 110. According to one embodiment, the messaging management system 102 is configured to communicate with the mobile computing device 104, dealer management system 106, and/or the third-party management system 108 to provide vehicle lifecycle messages, promotional material, useful tools, and other services to a user of the mobile computing device 104.

The mobile computing device 104 may run a mobile application that receives vehicle lifecycle messages and renders them for a user. The mobile computing device 104 may also provide information to the messaging management system 102 that affects the type of messages, message frequency, and other aspects of how messages are sent to the mobile computing device 104. For example, the mobile computing device 104 may provide vehicle identification information to the messaging management system 102. The mobile computing device 104 may provide other tools and functionality such as allow the user to search for vehicles, estimate a payment, schedule vehicle service, or the like.

The dealer management system 106 may provide service history information, purchase information, or other details to the messaging management system 102 to allow for more intelligent and targeted lifecycle messages, promotional messages, or other services. In one embodiment, the dealer management system 106 maintains a vehicle service account with information regarding past services performed on a vehicle owned by a user of the mobile computing device 104. The dealer management system 106 may provide other information such as a purchase history or messages submitted by a dealer for sending to one or more customers.

The third-party management system 108 provides information about a vehicle owned by the user of the mobile computing device 104 to the messaging management system 102 and/or the mobile computing device 104. For example, the third-party management system 108 may provide information regarding recalls for a vehicle. The third-party management system 108 may send or forward messages from an original equipment manufacturer (OEM) to the messaging management system 102 and/or mobile computing device 104. Examples of third-party management systems 108 may include or communicate with telematics systems such as OnStar® or other systems to receive lifecycle information and/or interface with a vehicle. In one embodiment, the third-party management system 108 may make a vehicle application programming interface (API) available to the messaging management system 102 and/or the mobile computing device 104 to allow them to interface with a vehicle. For example, messages may be sent through the vehicle API to determine a location of the vehicle, remotely start the vehicle, remotely unlock the vehicle, or provide other functions.

The messaging management system 102, mobile computing device 104, dealer management system 106, and third-party management system 108 are configured to communicate over a communication network 110. The network 110 may include one or more mobile communications networks, local area networks (LANs), wide area networks (WAN), the Internet, and/or various other networks.

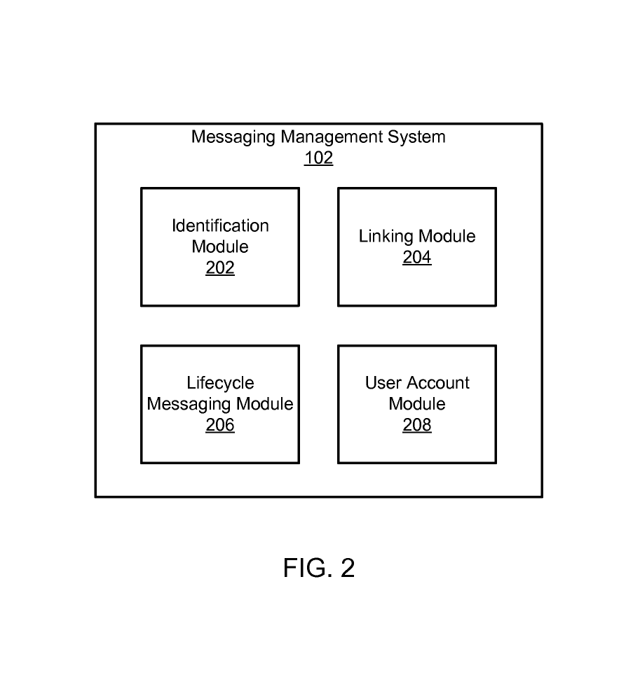

FIG. 2 is a schematic block diagram of a messaging management system 102. The messaging management system 102 includes an identification module 202, a linking module 204, a lifecycle messaging module 206, and a user account module 208. The modules 202, 204, 206, and 208 are exemplary only and varying embodiments may include only one or any combination of two or more of the modules 202, 204, 206, and 208 without limitation.

The identification module 202 receives vehicle identification information from a mobile computing device 104. The vehicle identification information may uniquely identify a vehicle, such as a vehicle owned by a user of the mobile computing device 104. For example, the vehicle identification information may uniquely identify a specific vehicle from all other vehicles of the same or different makes or models. In one embodiment, the vehicle identification information includes a vehicle identification number (VIN). In one embodiment, the vehicle identification information includes one or more details regarding the user. For example, the vehicle identification information may include a first name, last name, phone number, address, email address, or any other information corresponding to the user.

The linking module 204 links the mobile computing device 104 to a vehicle service account. In one embodiment, the linking module 204 links the mobile computing device 104 to a vehicle service account based on the vehicle identification information received by the identification module 202. The vehicle service account may include a service account maintained by a dealership, service center, or any other automotive related business. In one embodiment, the vehicle service account includes information regarding past service performed on the vehicle identified by the vehicle identification information. For example, the past services may include services performed prior to installing an application on the mobile computing device 104 or prior to the mobile computing device 104 providing the vehicle identification information to the messaging management system 102.

The linking module 204 may link the mobile computing device 104 to the vehicle service account by providing vehicle service account information to the mobile computing device 104, or by storing the vehicle service account information in an account corresponding to the mobile computing device 104. The linking module 204 may link the mobile computing device 104 to the vehicle service account by storing device information for the mobile computing device and associating the device information with the vehicle service account.

The lifecycle messaging module 206 provides lifecycle messages to the mobile computing device 104. In one embodiment, the lifecycle messaging module 206 provides lifecycle messages to the mobile computing device 104 that are based on a lifecycle stage of the vehicle. For example, the lifecycle messaging module 206 may provide different lifecycle messages depending on an age of the car, when the car was purchased, or other lifecycle details. Example lifecycle messages that are based on a lifecycle stage of a vehicle may include service reminders, a happy anniversary message that is sent on an anniversary of a purchase of the vehicle, promotions for available product or service upgrades, promotions for financial products and services, or other messages.

In one embodiment, during an early stage of the lifecycle of a vehicle messages that relate to needs, upgrades, services, or other products that are likely to be purchased in a time period shortly after purchasing the car may be sent. These early stage life cycle messages may include promotions for additional options for a car, prepaid maintenance programs, service warranties, or other products. Other messages may also be provided that include tips for how to use features of a newly purchased vehicle or other information useful to a new owner.

During later stages, the lifecycle messages may change to relate to the lifecycle of the car and/or the lifecycle of ownership of the car. For example, tips on how to use a car may not be sent as frequently the longer the vehicle has been owned. Similarly, messages for services needed during these later stages of the vehicle's life may be sent, such as messages regarding preventative maintenance that is recommended to take place at certain ages or mileage of the vehicle. Additionally, promotional messages relating to similar cars may also be provided as the vehicle ages and as a user may start to consider the purchase of a replacement vehicle.

The lifecycle messages sent by the lifecycle messaging module 206 may be based on other lifecycle details. In one embodiment, the lifecycle messages may be based on a service history of the vehicle. For example, a vehicle that has been poorly or irregularly serviced may receive different types of messages than a vehicle that has been frequently and regularly serviced. Similarly, lifecycle messages may be based on a combination of one or more of miles driven in the vehicle, an age of the vehicle, how long a current owner has owned the vehicle, or other information.

The lifecycle messages may also be based on what services or items have been purchased for the vehicle. For example, if a user purchased a prepaid maintenance program the lifecycle messages may include service reminders that indicate that the service has already been paid for. Similarly, if a user has leased a vehicle, the lifecycle messages may include notifications of expiration of the lease or other details regarding the lease. Also, the timing of specific lifecycle messages may be based on what was purchased. For example, certain services, such as a lease, may indicate that a user will likely be in the market for a new vehicle earlier than if the vehicle were simply purchased. Thus, the lifecycle messages and strategies may be customized or tailored to the needs or purchases of a specific user. If a customer has not purchased a service or upgrade, the lifecycle messaging module 206 may provide second chance offers or notifications. For example, a message may indicate that the user decided not to purchase a specific product or upgrade but may still do so. Low-pressure second chance offers may result in a customer deciding to make the purchase.

In one embodiment, purchasing of one item or upgrade for a vehicle may indicate a likelihood or need for purchasing another upgrade or service. For example, a customer who has purchased a hitch for a truck may be provided messages regarding trailer hook-up packages to control lighting and braking on a trailer, upgraded brakes, or other products. Additionally, the lifecycle messaging module 206 may predict, based on all information available regarding a vehicle or a customer, what the customer's likely next purchases will be and provide messages addressing those purchases.

The lifecycle messages may also be based on a current location of the mobile computing device 104. For example, special promotions, reminders, or other messages may be sent to a mobile computing device 104 when it enters a sales lot or comes near a store location. These location based messages may include promotions or other information that is not generally sent unless the user is located near or on the lot.

The lifecycle messages sent by the lifecycle messaging module 206 may be based on a variety of sources of information. In one embodiment, the lifecycle messages may be based on information gathered by a dealer and/or stored in a dealer management system 106. For example, the lifecycle messaging module 206 may receive or access data stored by the dealer management system 106 in a customer database or a vehicle service account. In one embodiment, the lifecycle messages may be based on information gathered by the mobile computing device 104 and/or entered by a user in the mobile computing device 104. For example, a user may be able to enter service history information, purchase information, communication preferences or other information into the mobile computing device. Additionally, the mobile computing device 104 may track whether a user has viewed a specific message and provide that information to the messaging management system 102. The lifecycle messages may also be based on information provided by an third-party management system 108. For example, information regarding recalls, a location of the vehicle, or other information may be provided by the third-party management system 108 to the messaging management system 102.

In one embodiment, the lifecycle messaging module 206 may format a message for display on the mobile computing device 104. According to one embodiment, the lifecycle messaging module 206 formats an image, text, or other information of a message for display on the mobile computing device 104. In one embodiment, the size, orientation, and configuration of a message may be modified depending on the type of mobile computing device 104. For example, the screen size, user interface, or other specific details of the mobile computing device 104 may determine how the message is formatted by the lifecycle messaging module 206.

The user account module 208 manages a user account corresponding to a user of the mobile computing device 104. The user account may store information corresponding to the user, one or more vehicles, or other information. In one embodiment, the user account module 208 controls creation of user accounts and/or access to user accounts. In one embodiment, the user account module 208 maintains an account for each mobile computing device 104 used for receiving vehicle lifecycle messages or for each user of the messaging management system 102.

The user account module 208 may store information corresponding to the user within the user account. The user account may be used to store any type of user or vehicle information which may affect sending of lifecycle messages as discussed above. In one embodiment, the user account may include user information, service history information, purchase history information, and user preference information. The user account module 208 may receive information from other systems or devices, such as the mobile computing device 104, the dealer management system 106, and the third-party management system 108 to be stored in the user account. In one embodiment, the user account module 208 may synchronize information in a user account maintained by the messaging management system 102 with information in a vehicle service account maintained by the dealer management system 106.

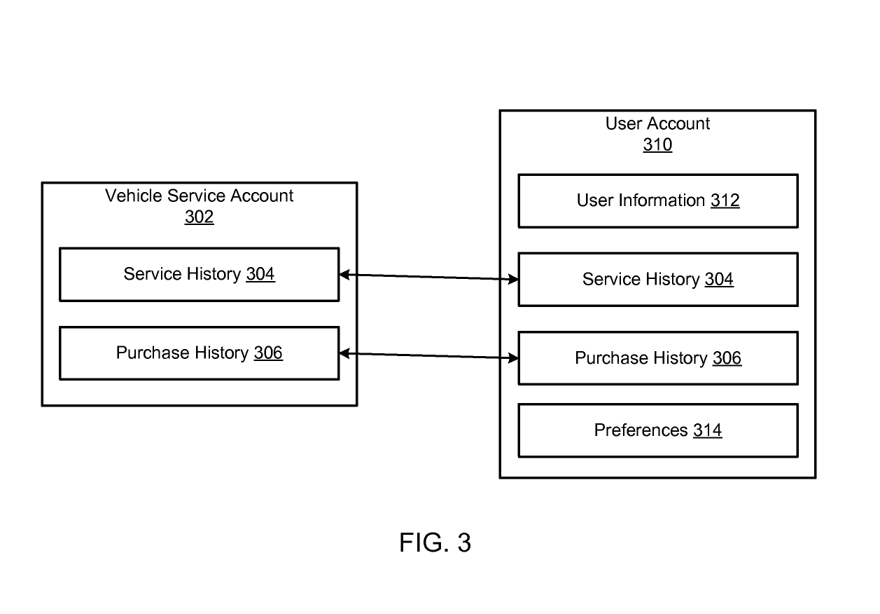

FIG. 3 shows schematic block diagrams of an example of a vehicle service account 302 and a user account 310. In one embodiment, the vehicle service account 302 is maintained by a dealer management system 106 and the user account 310 is managed by a user account module 208 of a messaging management system 102.

The vehicle service account 302 includes a service history 304, and a purchase history 306. In one embodiment, a dealer management system 106 updates the service history 304, and a purchase history 306 based on services performed on a vehicle by the dealer and/or based on purchases by the user. For example, each time a user brings in a vehicle for service the dealer management system 106 may add information about the performed vehicle service in the service history 304. Similarly, each item or service purchased at the dealer may be logged in the purchase history 306.

The user account 310 includes user information 312, a service history 304, a purchase history 306, and preferences 314. The user account module 208 may update each of the service history 304, the purchase history 306, and preferences 314 based on information provided by the dealer management system 106 and/or the mobile computing device 104. For example, the user account module 208 may update the service history 304 and the purchase history 306 of the user account 310 based on the vehicle service account 302 and/or information entered in the mobile computing device 104. The user account module 208 may upload information from the vehicle service account 302 into the user account 310. In one embodiment, information from the user account 310 may be used to update the vehicle service account. In one embodiment, the location of a service performed on or purchased for a vehicle may also be logged within the service history 304 or purchase history 306.

In one embodiment, the user account module 208 may store information about the user, such as the user's name, contact information, or other information in the user information 312 of the user account 310. The user account module 208 may also store information regarding use of the mobile computing device 104 in the user information 312. For example, the user account module 208 may receive information regarding whether specific lifecycle messages were viewed by the user from the mobile computing device 104 and store the information in the user information. Similarly, a name, contact information, age, gender, or other information about the user may be stored in the user information.

The user account module 208 may store user preferences 314 in the user account 310. For example, the user account module 208 may receive communication preferences from the mobile computing device 104 and store these in the user account 310. The preferences 314 may then be used by the lifecycle messaging module 206 to control the type, frequency, or other aspects of how messages are sent to the mobile computing device 104.

The user account module 208 may also allow integration with other accounts to allow a store, such as a dealer, or the user to share content with third parties. For example, integration with a user's Facebook® account may allow a dealer or other designated store to post feeds to the user's account and/or allow the user to share content from the user's account. In one embodiment, a user may be able to share a special offer or a picture of a newly purchased car through a mobile application.

In one embodiment, the user account module 208 may allow a user to create a mobile account from the mobile computing device 104. In one embodiment, the mobile computing device 104 runs a mobile application that is configured to interface with the messaging management system 102. In one embodiment, the mobile application allows the user to provide contact information and/or other information to the messaging management system 102 to create a new user account. Alternately, a user may use an existing account, such as a Facebook® account, to log in and/or create an new user account. Discussion of logging in and/or creating a new account from the mobile computing device 104 will be discussed further in relation to later figures.

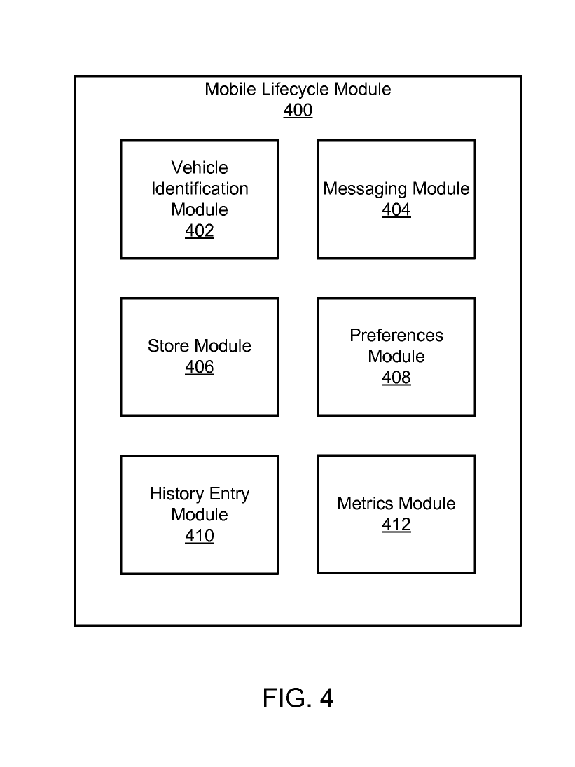

FIG. 4 is a schematic block diagram of one embodiment of a mobile lifecycle module 400 of a mobile computing device 104. The mobile lifecycle module 400 includes a vehicle identification module 402, a messaging module 404, a store module 406, a preferences module 408, a history entry module 410, and a metrics module 412. The modules 402, 404, 406, 408, 410, 412, are exemplary only and varying embodiments may include only one or any combination of two or more of the modules without limitation. In one embodiment, the mobile lifecycle module 400 includes code running on the mobile computing device 104. For example, the mobile lifecycle module 400 may include a mobile application installed on the mobile computing device 104.

The vehicle identification module 402 obtains vehicle identification information and provides the vehicle identification information to a service provider, such as a messaging management system 102, or other provider of lifecycle messages. In one embodiment, the vehicle identification module 402 obtains the vehicle identification information from a user. For example, the user may enter the information into an interface in the mobile computing device 104. In one embodiment, the vehicle identification module 402 obtains a VIN using a camera on the mobile computing device 104. The vehicle identification module 402 may provide the vehicle identification information to the messaging management system 102 to link the mobile computing device 104 to a specific vehicle service account.

The messaging module 404 receives lifecycle messages corresponding to a vehicle or the user. The lifecycle messages may be received from the messaging management module 102 or other service provider. For example, the messaging module 404 may receive lifecycle message provided by the lifecycle messaging module 206 of FIG. 2. In one embodiment, the lifecycle messages are received as in-application messages. For example, the messages may be sent to the mobile computing device 104 via a mobile application rather than via an email, text message such as via a short message service (SMS), or multimedia message such as via a multimedia messaging service (MMS). For example, the messaging module 404 may download messages provided by the lifecycle messaging module 206 over a web URL. In one embodiment, in-application messages may provide an increased measure of control to the user and/or the messaging management system 102 regarding sent messages with regard to other messaging methods. For example, regulatory limitations for text messages may not apply and a user may be able to easily change message preferences within the application.

In one embodiment, the messaging module 404 provides a notification to a user that the message has been received. The notification may be an in-application notification or a system notification. For example, the messaging module 404 may provide a system notification in a notification bar of an operating system such as in iOS®, Android®, or other mobile operating system. In one embodiment, the notification may be provided as a pop up notification within the system. A user may be able to view and/or select the notification to be taken to the received message. In one embodiment, the notification to the user may be provided in real time. For example, the messaging module 404 may notify a user of receipt of the message as soon as the message is received. Similarly, the messaging module 404 may frequently check for and/or receive new messages to provide real time communication with the mobile computing device 104.

The store module 406 determines a vehicle service venue to be designated as a preferred store. In one embodiment, the store module 406 determines the vehicle service venue to be designated as the preferred store based on how installation of the mobile lifecycle module 400 was initiated. In one embodiment, for example, a user may scan a quick response (QR) code using the mobile computing device 104 at a dealership which brings up a link to install the mobile lifecycle module 400 as a mobile application. The QR code may correspond to the dealership and thus the downloaded application may be installed with the dealership as the preferred store. Similarly, the store module 406 may determine a preferred stored base on a link from a store website or other location or link that corresponds to the dealer. For example, a link on a dealer website may be used to initiate download of the lifecycle management module 400 and the store module 406 links the mobile computing device 104 to the store that corresponds to the dealer website.

In one embodiment, the store module 406 determines the vehicle service venue to be designated as the preferred store based on a location of the mobile computing device 104 at the time of downloading of the mobile lifecycle module 400 as a mobile application. For example, a global positioning system (GPS) receiver, or other positioning system receiver or module, in the mobile computing device 104 may determine a location of the mobile computing device and the store module 406 may determine that the closest store is the preferred store. In one embodiment, the store module 406 provides a list of the closest service venues and allows the individual to choose one of them as the preferred store. In one embodiment, a service venue may be any store, location or venue where automobile services, parts, or vehicles may be purchased or performed.

In one embodiment, the store module 406 determines the vehicle service venue to be designated as a preferred store based on information provided by the user. For example, the store module 406 may provide an interface to the user to allow the user to search for, view, and select a preferred store from a number of stores. In one embodiment, the interface may suggest specific stores based on a location of the mobile computing device 104 or how installation of the mobile lifecycle module 400 was initiated and allow the user to pick a store or locate a different store.

The store module 406 provides information regarding the preferred store to the messaging management system 102. In one embodiment, the preferred store determined by store module 406 affects operation of the messaging management system 102 in relation to the specific mobile computing device 104. For example, the lifecycle messages may be branded for the preferred store and may be related to services or products provided by the preferred store. Similarly the messages may be based on messages produced or requested by the preferred store.

In one embodiment, the store module 406 controls an interface provided by the mobile lifecycle module 400 to reflect branding of a preferred store. For example, colors of arrows, features, symbols, or other aspects of the interface may reflect the branding of the preferred store. Additionally, the preferred store name and/or logo may be listed at various locations throughout the interface. Other branding, such as that of a parent company, a producer of the mobile application, or other business may be minimized or eliminated to reduce the chance that the application might draw a customer to a competitor's store or services. Thus, a mobile application may appear to the user to be produced by the preferred store.

The preferences module 408 receives preferences from a user regarding operation of the mobile lifecycle module 400 and/or the messaging management system 102. In one embodiment, the preferences module 408 provides an interface for the user to provide preferences regarding lifecycle messages. For example, the preferences may include the types of messages sent, the subject matter of the messages, the frequency of the messages, or other details so that the user is not annoyed or overwhelmed by the messages, or manner of delivery of the messages, but receives the messages that are important to the user.

The history entry module 410 receives service history and purchase history information from a user. In one embodiment, the history entry module 410 provides an interface to allow a user to enter information regarding service performed on a vehicle. For example, the user may enter a date, price, location, mileage, type of oil, or other information for an oil change service performed on the vehicle. Similarly, the user may enter information regarding accessories or parts purchased for the vehicle. The user may also enter information regarding a prepaid maintenance plan, insurance, or other services purchased in relation to the vehicle. In one embodiment, the history entry module 410 may provide the received information to the messaging management system 102 for storage in a user account 310.

The metrics module 412 gathers usage metrics for the mobile lifecycle module 400. In one embodiment, the metrics module 412 logs information regarding whether a message has been viewed, how long a user has stayed on a specific interface screen, or other usage metrics for the usage for the mobile lifecycle module 400. In one embodiment, the metrics module 412 provides the usage metrics to the messaging management system 102 which may allow more targeted or useful messages or other services to be provided to a user of the mobile computing device 104. For example, the lifecycle messaging module 206 may be able to determine that a specific message was read and determine not to send that message again or not as frequently as if the message had not been viewed.

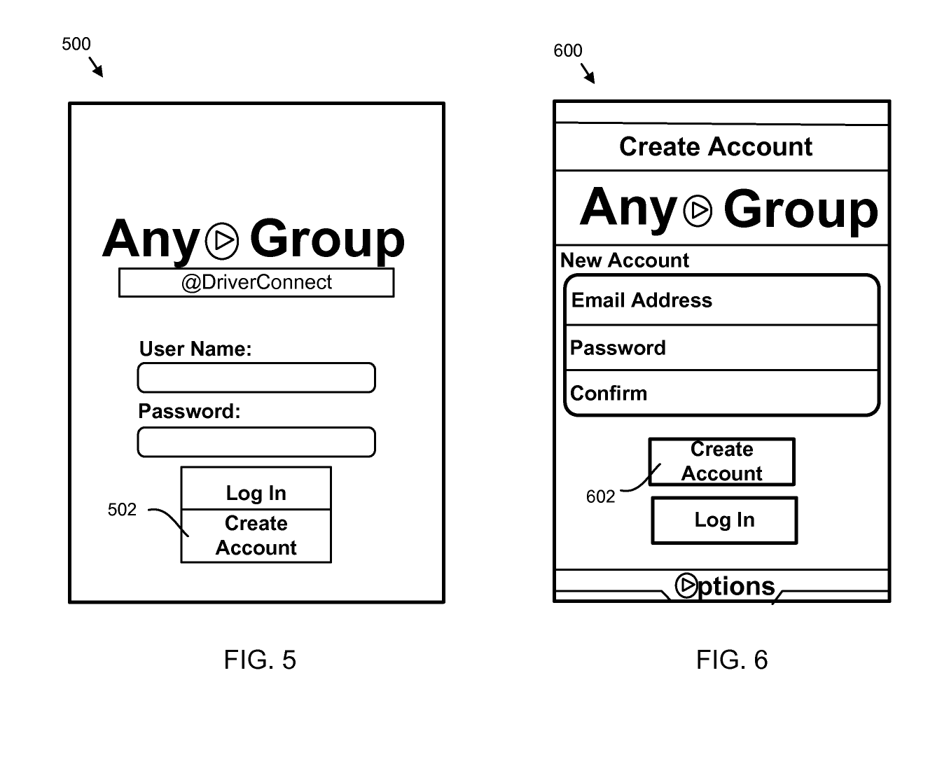

FIGS. 5-20 are example screenshots of an interface provided by a mobile application on a mobile computing device 104. In one embodiment, the interface is provided by the mobile lifecycle module 400. FIG. 5 illustrates an example login interface 500. In one embodiment, the login interface 500 may allow a user to login to an existing user account or to create a new account. The user may enter corresponding information into the mobile computing device 104 and the messaging management system 102 may allow or deny the login. If a user successfully logs in, a home screen of the application may be displayed. If a user does not yet have an account the user may select the create account 502 option to be provided an interface to create a new account from the mobile computing device 104. In one embodiment, even if the user does not yet have an account the user may use an existing account, such as a Facebook®, Google®, or other account, to log into the system or application.

FIG. 6 illustrates an example create account interface 600. The create account interface 600 allows a user to provide an email address and a password. In one embodiment, the mobile lifecycle module 400 may auto-populate the email address with an email address associated with the mobile computing device 104. The user may select the create account option 602 to cause the mobile computing device 104 to send a create account request to the messaging management system 102. In one embodiment, the messaging management system 102 may create an account and send information to the mobile application 104 indicating creation of the account.

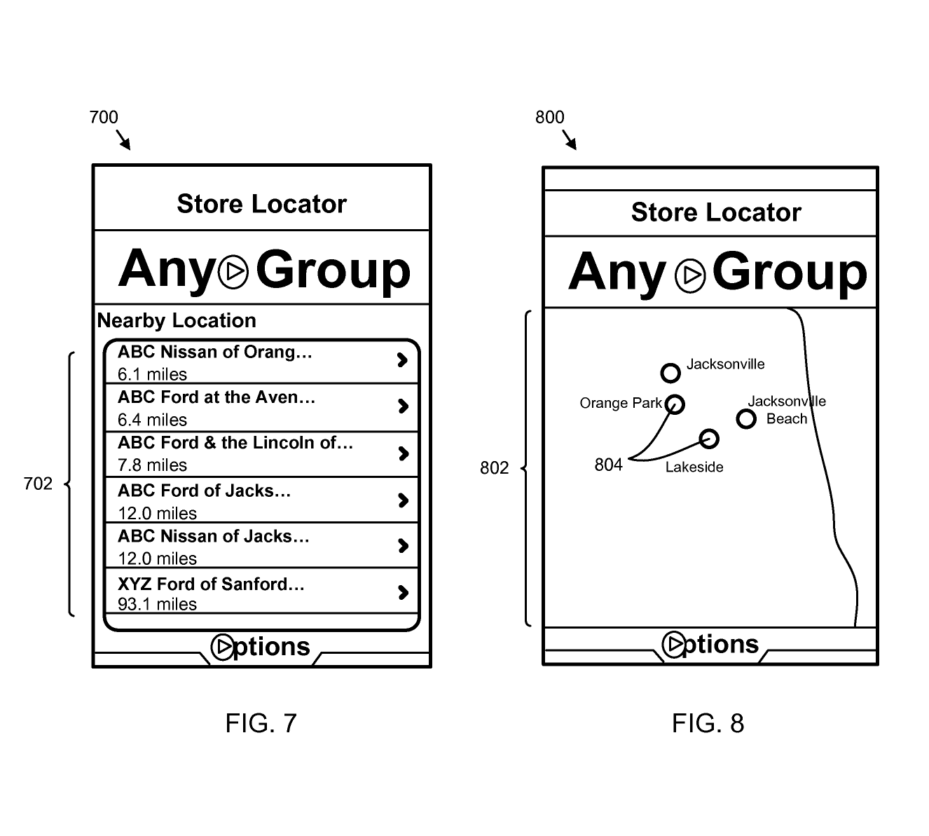

FIGS. 7 and 8 illustrate example store locator interfaces 700, 800 for associating the mobile computing device 104 with a preferred store or a preferred group of stores. In one embodiment, one or both of the store locator interfaces 700, 800 may be provided to allow a user upon first use of the mobile lifecycle module 400 to select the preferred store. For example, a store locator interface 700, 800 may be provided before or after creating or logging into an account. In one embodiment, the preferred store may be selected based on a download link or other information associated with a specific store. In one embodiment, the store module 406 of FIG. 4 may provide one or both of the store locator interfaces 700, 800.

FIG. 7 illustrates a store locator interface 700 that includes a list 702 of nearby stores from which the user may select a preferred store. In one embodiment, the list 702 of stores is based on a location of the mobile computing device 104 at the time of store selection. For example, if the mobile computing device 104 includes a global positioning (GPS) receiver, the list 702 of stores may be based on the current location of the mobile computing device 104. In another embodiment, the list 702 of stores is based on a web link used to initiate installation of the mobile lifecycle module 400. In one embodiment, the interface 700 may provide a search feature for a user to search for a specific store. For example, the user may be able to search for a specific store even if it does not show up in the list 702 or is not located nearby.

FIG. 8 illustrates a store locator interface 800 that includes a map 802 with store location indicators 804 showing a location of one or more stores. In one embodiment, a user may select one of the store location indicators 804 to view additional information about the store and/or select the store as a preferred store. The map 802 may be slidable such that the user may slide the map 802 around to move to another location and zoom in or out of the map 802.

In one embodiment, once the preferred store is set the store module 406 may provide information indicating the preferred store to the messaging management system 102. In one embodiment, the messaging management system 102 may link the mobile computing device 104 to the preferred store and/or a vehicle service account at the preferred store.

Additionally, once the preferred store is set the mobile application may operate with respect to the specific store and/or a group of stores to which that preferred store belongs. For example, if a specific dealership is added as a preferred store, the application may be able to search, view inventory, and/or receive lifecycle messages from a dealer group of which the preferred store is a part. The mobile application and its associated interfaces may still provide customized branding for the preferred store but the functions of the application may be performed with respect to the whole dealer group and all the other dealerships or stores within the dealer group.

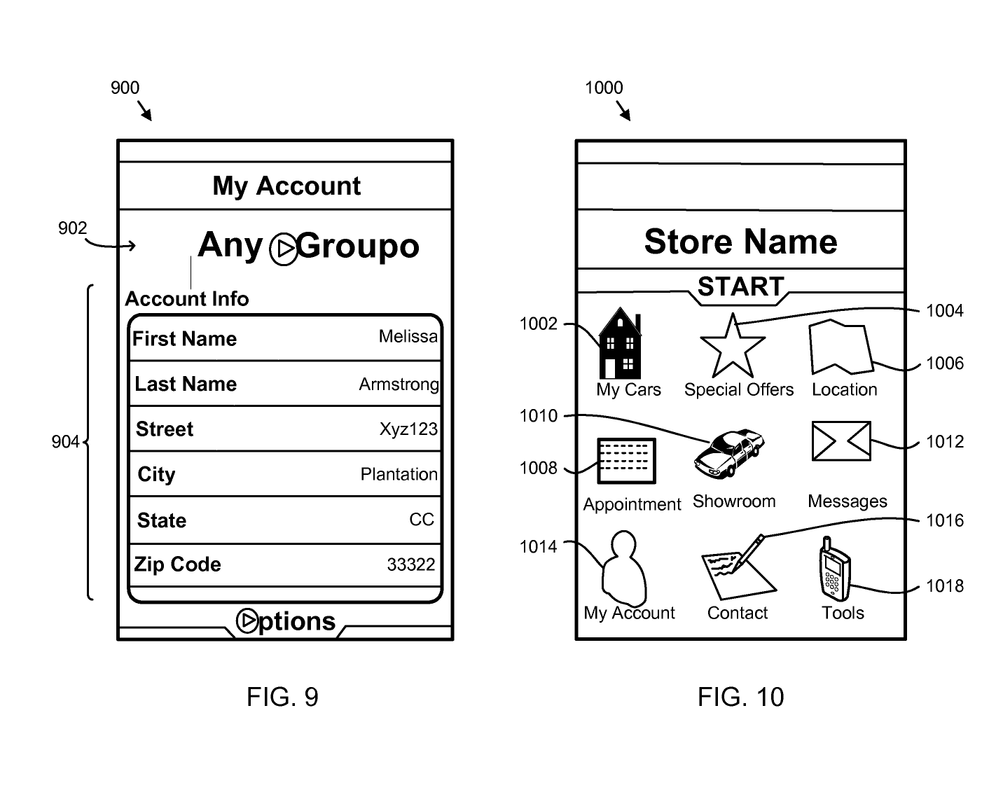

FIG. 9 illustrates an example my account interface 900. The my account interface 900 may be displayed after creation of an account and/or selection of a preferred store. The my account interface 900 shows the preferred store name 902 as well as account information 904 for the user's account. In one embodiment, the branding of the my account interface 900 and many or all other interfaces of the mobile application may be adjusted to reflect the branding of the preferred store.

FIG. 10 illustrates an example home screen interface 1000. The home screen interface 1000 displays a number of icons 1002-1018 for accessing other portions of a mobile application. The icons include a my cars icon 1002, a special offers icon 1004, a location icon 1006, an appointment icon 1008, a showroom icon 1010, a messages icon 1012, a my account icon 1014, a contact icon 116, and a tools icon 118. The depicted icons 1002-1018 and associated interfaces are given by way of example only. Fewer or additional icons or interfaces may be available in some embodiments.

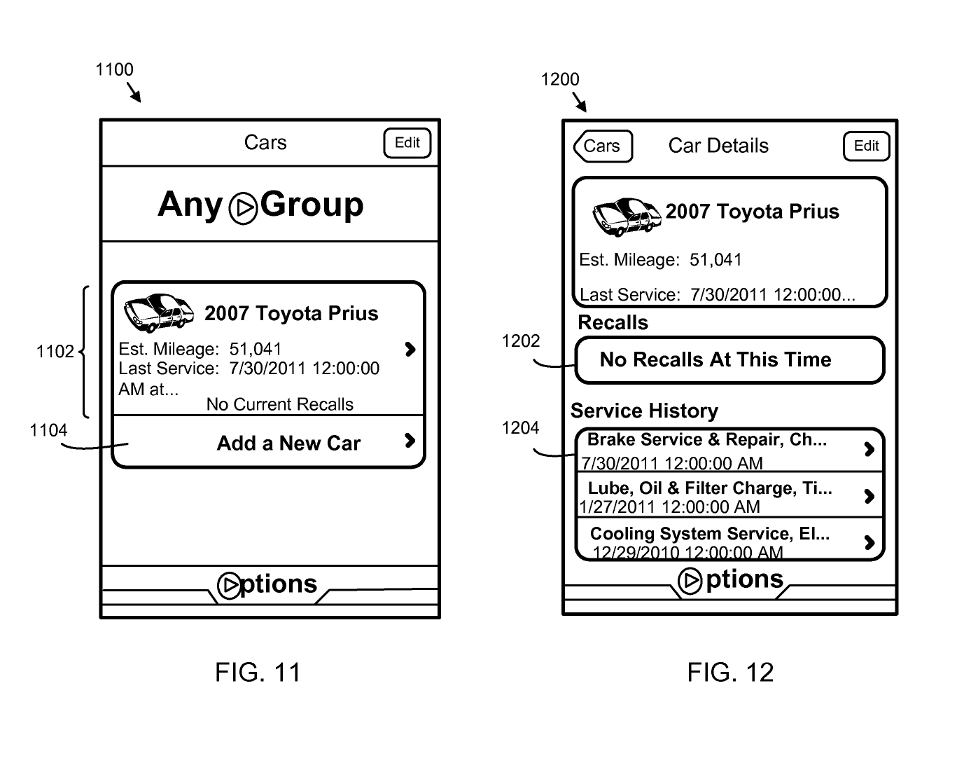

The my cars icon 1002 may be selected to display a my cars interface. FIG. 11 illustrates an example my cars interface 1100. The my cars interface 1100 lists a vehicle 1102. The vehicle 1102 may be a vehicle owned by the individual and for which a mobile computing device 104 receives lifecycle messages. Details regarding a vehicle may be viewed by selecting the vehicle 1102. Additional vehicles may be added using the add a new car option 1104.

FIG. 12 illustrates a car details interface 1200 that may be provided in response to a selection of the vehicle 1102. The car details interface 1200 lists a variety of information about the vehicle 1102 such as recall information 1202, service history information 1204, or any other information. According to one embodiment, even more specific information may be provided in response to selecting the recall information 1202, service history information 1204, or any other information on the car details interface 1200.

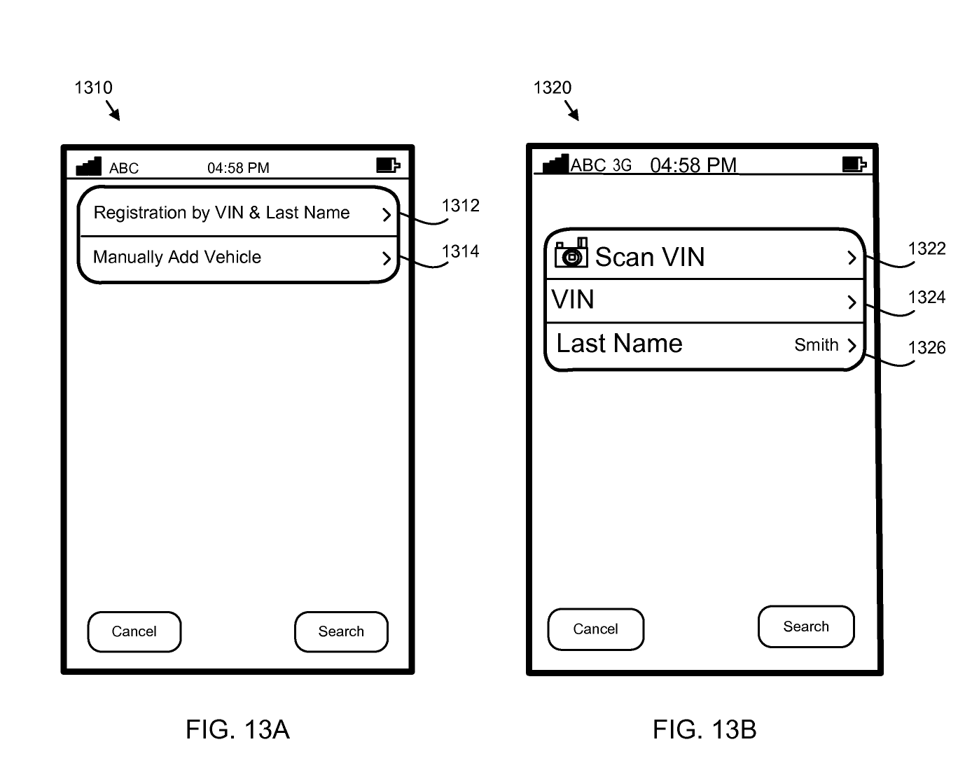

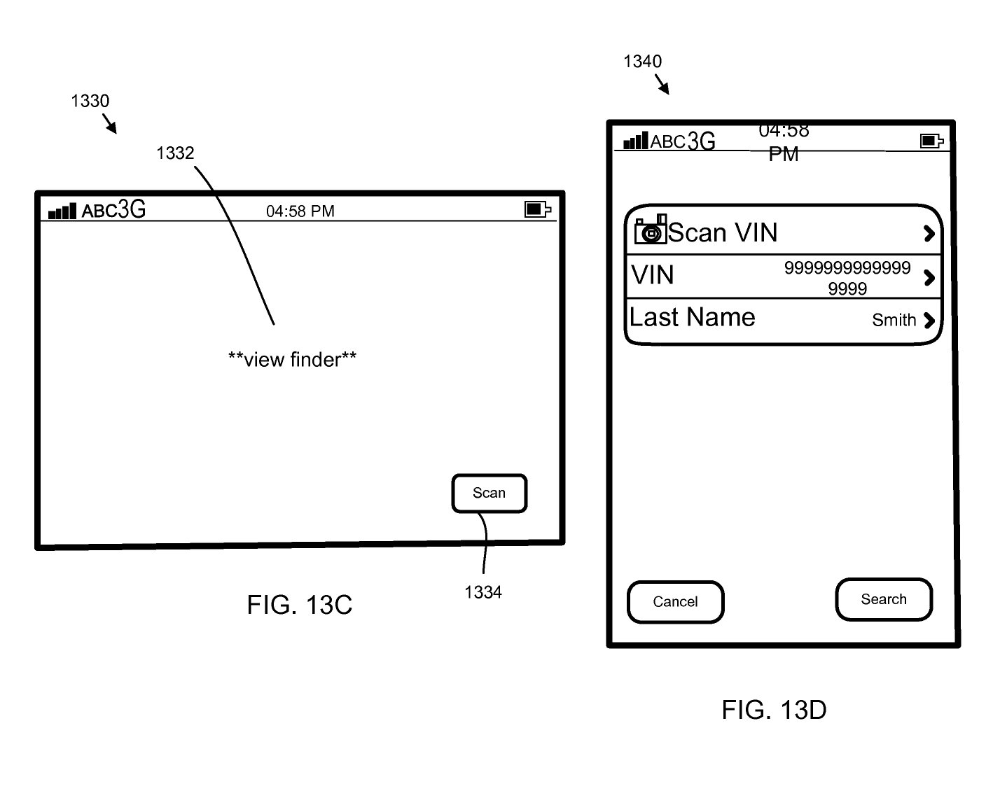

In one embodiment, selection of the add a new car option 1104 of FIG. 11 will bring up an interface to provide vehicle identification information, which may be used to add a new car to the mobile application and/or a user account 310. FIGS. 13A through 13D illustrate an interface and method for obtaining vehicle identification information.

FIG. 13A illustrates an interface 1310 for adding a new vehicle within a mobile application on a mobile computing device 104. The interface 1310 includes a first option 1312 for registering a vehicle by VIN and last name of a user. Selection of the first option 1312 will provide an interface to obtain a VIN of a vehicle and last name of the owner. The interface 1302 also includes a second option 1314 for manually adding the vehicle. Selection of the second option 1314 provides an interface to manually select the make, model, and other details of a vehicle. The interface 1310 further includes cancel and search options for cancelling the addition of a vehicle or to search for a vehicle to add.

FIG. 13B illustrates an interface 1320 displayed after selection of the first option 1312 of FIG. 13A. The interface 1320 shows a first option 1322 to scan a VIN, a second option 1324 to manually enter a VIN, and a third option 1326 to modify a last name. The first option 1322 is used to scan a VIN on a vehicle using a camera to automatically capture the VIN. This may allow the user to skip entering the long VIN and may reduce risk of error in the VIN entry. The second option 1324 allows the user to manually enter the VIN using a keypad or keyboard of the mobile computing device 104. The third option 1326 allows a user to modify an automatically populated last name. For example, the vehicle identification module 402 may automatically populate the last name based on information already stored within the mobile computing device 104.

FIG. 13C illustrates an interface 1330 displayed after selection of the first option 1322 of FIG. 13B. The interface 1330 includes a view finder 1332 where images captured by a camera of the mobile computing device 104 are displayed. The user may orient the camera until the VIN is within view. The vehicle identification module 402 may capture the VIN when it is properly in view. In one embodiment, a user can select a scan option 1334 to capture the VIN when it comes into view.

FIG. 13D illustrates an interface 1340 after a VIN has been captured or entered. The VIN is displayed which may allow the user to confirm that the VIN is accurately entered. In one embodiment, the vehicle identification information may be stored within the mobile computing device and the vehicle may be added as a user's car within the mobile computing device 104. For example, the vehicle may be listed in the my car interface 1100 of FIG. 11. In one embodiment, the vehicle identification module 402 provides the VIN and last name to the messaging management system 102. The messaging management system 102 may link the mobile computing device 104 to a specific vehicle service account 302 upon receipt of the vehicle identification information.

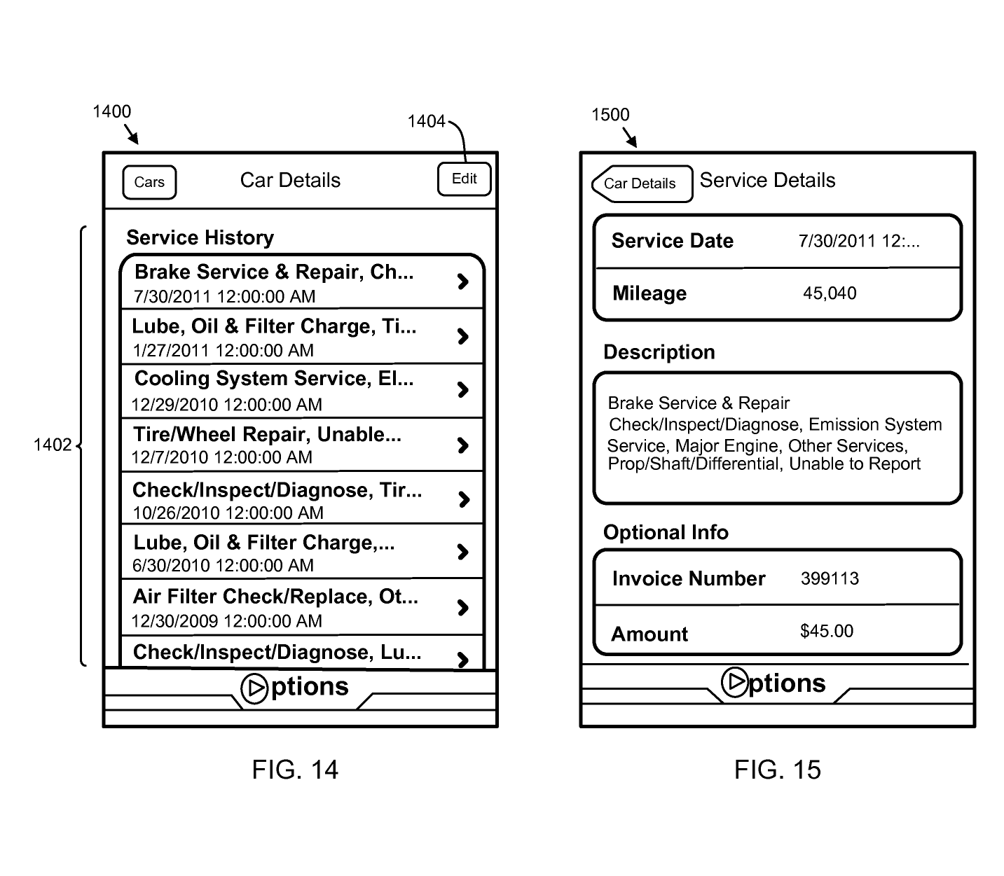

FIG. 14 illustrates an example service history interface 1400. In one embodiment, the service history interface 1400 may be displayed in response to selecting the service history information 1204 from the car details interface 1200 depicted in FIG. 12.

The service history interface 1400 provides a service history list 1402 of services performed on a specific vehicle. The service history list 1402 may include services stored in a service history 304 of a vehicle service account 302 or a user account 310. In one embodiment, the service history list 1402 is pulled from a user account corresponding to the mobile computing device 104. The service history list 1402 services may be synchronized and/or updated with service histories 304 managed by the messaging management system 102 and/or the dealer management system 106.

The interface 1400 provides an edit option 1404 to allow a user to edit the service history list 1402 by modifying existing entries, removing existing entries, and/or adding new service entries. For example, a user may add a service that has been performed by a service center that is not configured to communicate with the messaging management system 102. The history entry module 410 may provide an interface for allowing the user to enter services performed, purchases, or other information.

FIG. 15 illustrates a service details interface 1500. The service details interface 1500 may be presented in response to a user selecting a specific item from the service history list 1402. The service details interface 1500 provides more specific information about a specific service that was performed.

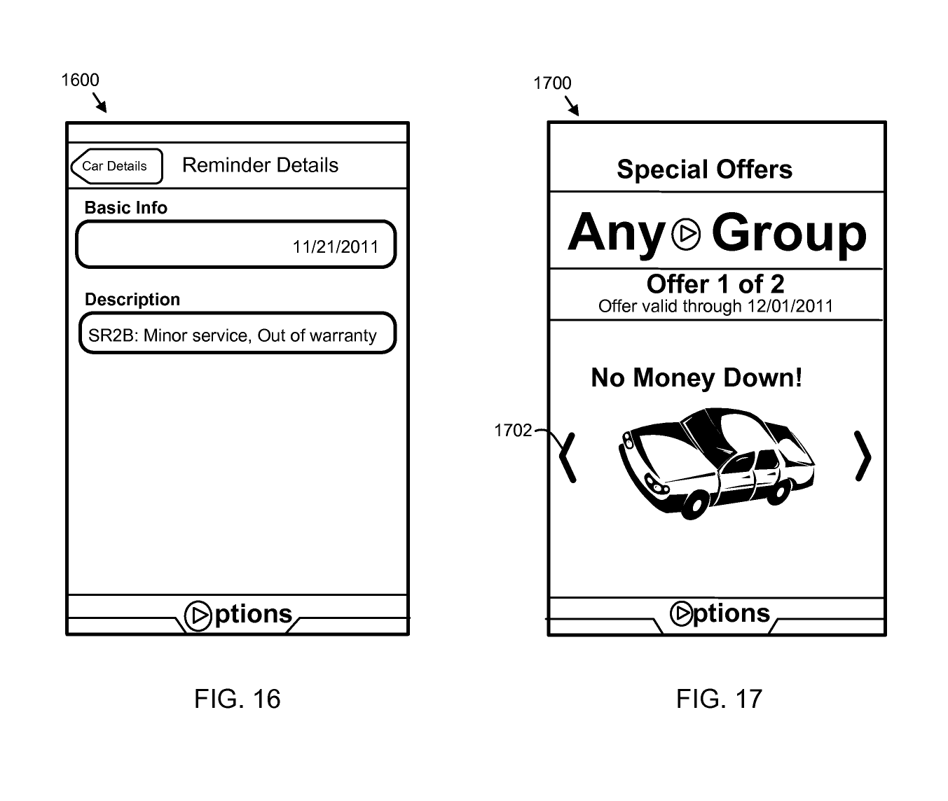

FIG. 16 illustrates a service reminder interface 1600 which provides a service reminder. The service reminder may be a reminder of service to be performed on a specific vehicle. For example, the service reminder may remind of the need to perform an oil change or perform other maintenance or service on the vehicle 1102. The service reminder interface 1600 may be accessible through a variety of locations in a mobile application. For example, the service reminder interface 1600 may be accessible through the car details interface 1200, service history interface 1400, service details interface 1500 or other interfaces.

Returning to FIG. 10, the special offers icon 1004 may be selected to display a special offers interface for viewing special offers. The special offers may include offers provided in a lifecycle message from the messaging management system 102. FIG. 17 illustrates an example of a special offers interface 1700 for displaying special offers. In one embodiment, a user may scroll through special offers by scrolling or swiping from offer to offer. Arrow 1702 may be used to indicate that additional offers are available in addition to the displayed special offer.

Returning to FIG. 10, the location icon 1006 may be selected to locate a dealer, service station, or other store. In one embodiment, selection of the location icon 1006 may bring up a store locator interface, such as the store locator interfaces 700, 800 of FIGS. 7 and 8.

The appointment icon 1008 may be selected to bring up an appointment interface to set up a service appointment or view details regarding an existing appointment. In one embodiment, the appointment interface may allow a user to select a date, time, vehicle, service, and/or service location for a service appointment. In one embodiment, the appointment interface may be used to correspond with the messaging management system 102 or dealer management system 106 to schedule the appointment with a specific service station or location.

The showroom icon 1010 may be selected to bring up a showroom interface. The showroom interface may allow a user to browse and/or search for new or used cars and inventory available at one or more dealerships. The showroom interface may include images, customization options, availability, and other details of vehicle to help a user see what is available. In one embodiment, upon selection or viewing of a specific vehicle, or make and model of vehicle, the user may be able to request a quote for the vehicle. A dealership or other store may then respond to the request with a quote on the price and other details associated with a sale.

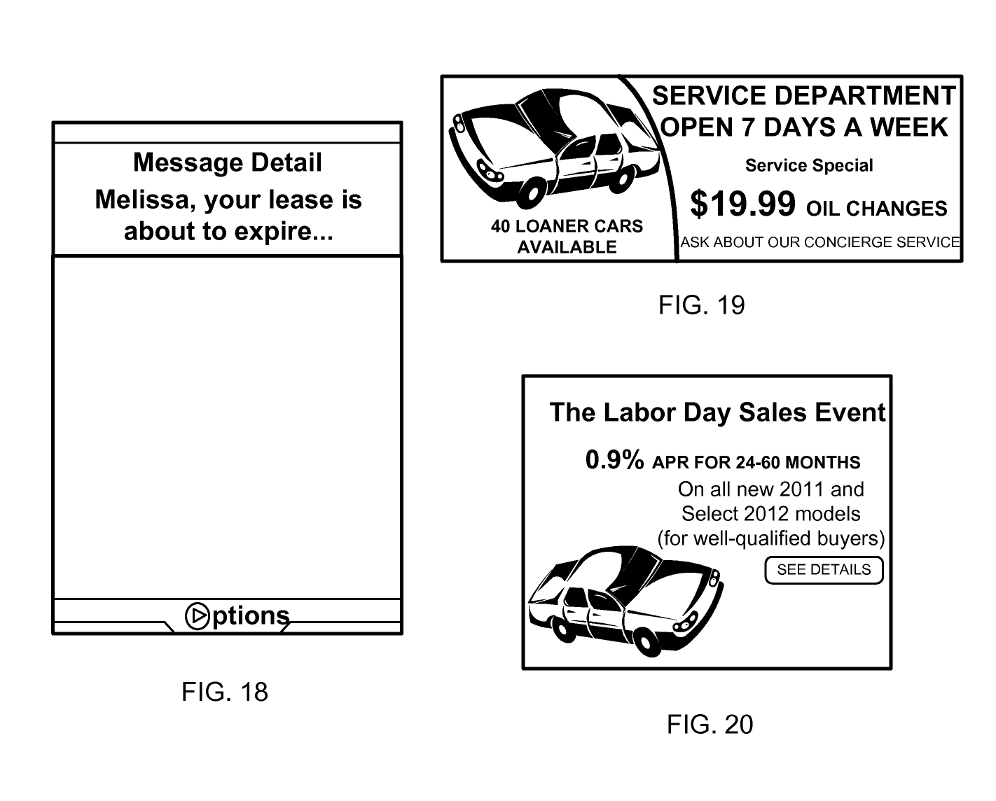

The messages icon 1012 may be selected to bring up messages received from the messaging management system 102. FIGS. 16, 17, 18, 19, and 20 illustrate exemplary messages which may be received and/or displayed through a mobile computing device 104. FIG. 18 includes a message regarding upcoming expiration of a lease. FIG. 19 includes a message regarding a service special and other information about services provided at a service center. FIG. 20 includes a message for an upcoming labor day sale and lending details that are available during the sale.

The my account icon 1014 may be selected to bring up an interface displaying account information for a user of the mobile computing device 104. In one embodiment, the my account icon 1014 may bring up the my account interface 900 of FIG. 9.

The contact icon 1016 may provide an interface with information for contacting a preferred store, technical support, or other service provider. In one embodiment, the contact icon 1016 may provide contact information such as an address, email address, or phone number for the preferred store.

The tools icon 1018 may provide a variety of useful tools for a user. For example, various calculators, links, or phone functions may be provided within a tools interface to provide tools that may be needed by car shoppers or car owners.

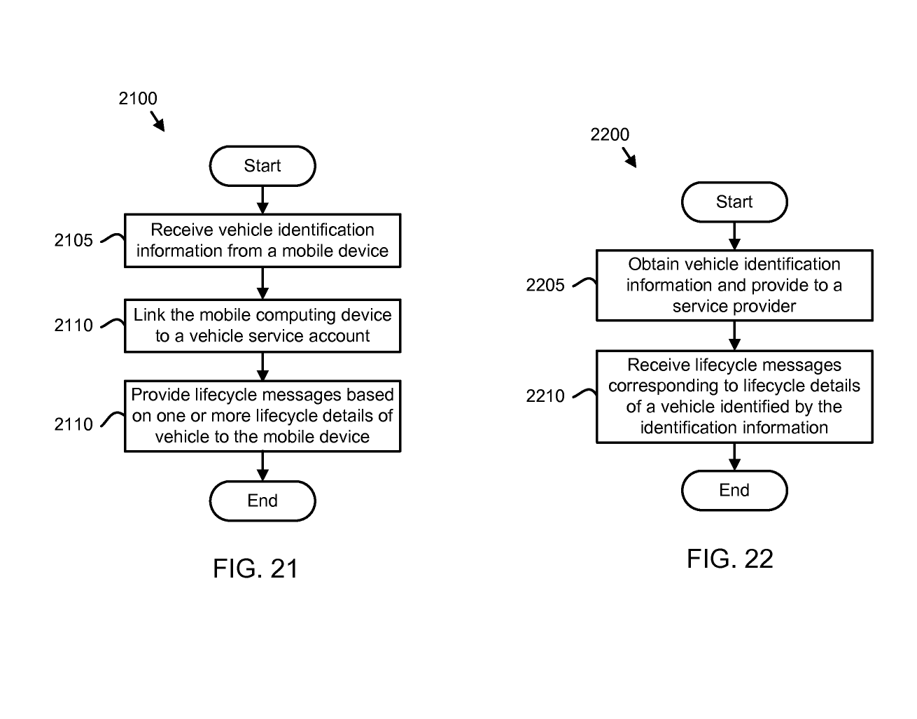

FIG. 21 is a schematic flow chart diagram illustrating a method 2100 for sending vehicle lifecycle messages to a mobile computing device. In one embodiment, the method 2100 is performed by a messaging management system 102.

The method 2100 includes an identification module 202 receiving 2105 vehicle identification information from a mobile computing device 104. For example, the identification module 202 may receive the vehicle identification information from a vehicle identification module 402 installed on a mobile computing device. The vehicle identification information uniquely identifies a vehicle. In one embodiment, the vehicle identification information comprises a VIN and a name of an owner.

A linking module 204 may link 2110 the mobile computing device 104 to a vehicle service account. The vehicle service account is linked 2110 to the mobile computing device 104 based on the vehicle identification information received 2105 by the identification module 202. In one embodiment, the vehicle service account includes a service history and/or a purchase history for the vehicle. The service history may include information regarding services performed on the vehicle and may limit any need for an individual to manually enter vehicle service information.

A lifecycle messaging module 206 may provide 2110 lifecycle messages to the mobile computing device 104. The lifecycle messages provided 2110 by the lifecycle messaging module 206 may be based on one or more lifecycle details of the vehicle. For example, the provided 2110 lifecycle messages may be based, at least in part, on information stored in the vehicle service account. In one embodiment, as the vehicle ages and/or as an owner owns the same vehicle longer the lifecycle messages may change to reflect the current stage of the vehicle or the current lifecycle details of the vehicle or owner.

FIG. 22 is a schematic flow chart diagram illustrating a method 2200 for receiving lifecycle messages for a vehicle on a mobile computing device. In one embodiment, the method 2200 is performed by a mobile lifecycle module 400. For example, the mobile lifecycle module 400 may include a mobile application installed on a mobile computing device 104.

A vehicle identification module 402 obtains 2205 vehicle identification information and sends the identification information to a service provider. The vehicle identification module 402 may obtain 2205 information uniquely identifying a vehicle. For example, the vehicle identification module 402 may obtain a VIN that uniquely identifies the vehicle from all other vehicles. The vehicle identification module 402 also provides the identification information to a service provider. The service provider may include a messaging management system 102 or other provider of lifecycle messages.

A messaging module 404 receives 2210 a lifecycle message corresponding to the a vehicle associated with the vehicle identification information. The messaging module 404 may receive 2210 the lifecycle messages from the service provider, such as the messaging management system 102. The received 2210 lifecycle message is based on one or more lifecycle details of the vehicle identified by the vehicle identification information.

Some of the components that can be used with embodiments disclosed herein are already available, such as general-purpose computers, mobile phones, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software module may include any type of computer instruction or computer executable code located within or on a non-transitory computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

The systems and methods disclosed herein are not inherently related to any particular computer or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory digital processing apparatus memory device.

One of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

It will be obvious to those having skill in the art that many changes may be made to the details of the above-described embodiments without departing from the underlying principles of the invention. The scope of the present invention should, therefore, be determined only by the following claims.

1. A method for providing vehicle lifecycle messages, the method comprising:
receiving vehicle identification information from a mobile computing device, the vehicle identification information uniquely identifying a vehicle;
linking the mobile computing device to a vehicle service account based on the vehicle identification information; and
providing a lifecycle message to the mobile computing device, the lifecycle message based on one or more lifecycle details of the vehicle.

2. The method of claim 1, further comprising determining the lifecycle message to be provided to the mobile computing device.

3. The method of claim 2, wherein determining comprises determining the lifecycle message based on information in the service account.

4. The method of claim 2, wherein determining comprises determining the lifecycle message based on information gathered by the mobile computing device.

5. The method of claim 2, further comprising formatting the lifecycle message for the mobile computing device.

6. The method of claim 1, wherein the service account comprises a service station account.

7. The method of claim 1, wherein the service account comprises a dealership account.

8. The method of claim 1, wherein linking the mobile computing device to the vehicle service account comprises linking the mobile computing device to an existing service account.

9. The method of claim 8, wherein the existing service account comprises information regarding past services performed on the vehicle.

10. The method of claim 1, further comprising creating the vehicle service account in response to receiving the vehicle identification information.

11. The method of claim 1, wherein the vehicle identification information comprises a vehicle identification number (VIN).

12. The method of claim 1, wherein the vehicle identification information comprises information linked to an owner's name.

13. The method of claim 1, wherein the one or more lifecycle details comprise a service history of the vehicle.

14. The method of claim 1, wherein the one or more lifecycle details comprise an age of the vehicle.

15. The method of claim 1, wherein the one or more lifecycle details comprise a purchase date of the vehicle.

16. The method of claim 1, wherein the one or more lifecycle details comprise miles driven by the vehicle.

17. The method of claim 1, wherein the one or more lifecycle details comprises services purchased for the vehicle.

18. The method of claim 1, wherein the one or more lifecycle details comprise items purchased for the vehicle.

19. A lifecycle messaging management system, the system comprising:
an identification module for receiving vehicle identification information from a mobile computing device, the vehicle identification information uniquely identifying a vehicle;
a linking module for linking the mobile computing device to a vehicle service account based on the vehicle identification information; and
a lifecycle messaging module for providing lifecycle messages to the mobile computing device, the lifecycle messages based on a lifecycle stage of the vehicle.

20. The system of claim 19, wherein the lifecycle messages are further based on a current location of the mobile computing device.

21. The system of claim 19, wherein the lifecycle messages are further based on a purchase history of an owner.

22. The system of claim 19, wherein the lifecycle messages are further based on predicted likely purchases for the vehicle.

23. The system of claim 19, wherein the lifecycle messages are based on whether the vehicle has been serviced at another location.

24. The system of claim 19, wherein the lifecycle messages comprise information regarding a sales promotion.

25. The system of claim 24, wherein the sales promotions comprises second chance offers.

26. The system of claim 24, wherein the sales promotions comprises promotions for vehicle upgrades.

27. The system of claim 24, wherein the sales promotions comprises promotions for service upgrades.

28. The system of claim 19, wherein the lifecycle message reflects services purchased.

29. The system of claim 28, wherein the lifecycle messages comprise vehicle service reminders, and wherein the vehicle service reminders indicate that a vehicle service has already been paid for.

30. A mobile computing device comprising:
a vehicle identification module for obtaining vehicle identification information uniquely identifying a vehicle and providing the vehicle identification information to a service provider; and
a messaging module for receiving a lifecycle message corresponding to the vehicle from the service provider and providing a notification to the user that the lifecycle message was received, the lifecycle message based on one or more lifecycle details of the vehicle.

31. The mobile computing device of claim 30, further comprising a mobile application installed on the mobile computing device, the mobile application comprising the vehicle identification module and the messaging module.

32. The mobile computing device of claim 31 wherein the messaging module is configured to receive the lifecycle message as a push message from the service provider.

33. The mobile computing device of claim 31, wherein the messaging module is configured to receive the lifecycle message as a pull message from the service provider.

34. The mobile computing device of claim 30, wherein the messaging module providing the notification to the user comprises providing a real time notification that the lifecycle message was received.

35. The mobile computing device of claim 30, further comprising a venue module for linking the mobile computing device to a vehicle service venue.

36. The mobile computing device of claim 35, wherein the vehicle service venue comprises a service station and wherein the venue module links the mobile computing device to the service station.

37. The mobile computing device of claim 35, wherein the vehicle service venue comprises a vehicle dealership and wherein the venue module links the mobile computing device to the vehicle dealership.

38. The mobile computing device of claim 35, wherein the venue module links the mobile computing device to the vehicle service venue based on a web address used to initiate a mobile application download.

39. The mobile computing device of claim 35, wherein the venue module further modifies a branding of a mobile application running on the mobile computing device, the branding corresponding to the vehicle service venue.

40. The mobile computing device of claim 30, further comprising a preferences module for receiving input from the user indicating communication preferences.

41. The mobile computing device of claim 40, wherein the communication preferences comprise topic preferences for receiving lifecycle messages based on a topic of the lifecycle messages.

42. The mobile computing device of claim 40, wherein the communication preferences comprise frequency preferences for frequency for how frequent lifecycle messages are received.

43. The mobile computing device of claim 40, wherein the communication preferences comprise service interval preferences for receiving lifecycle messages indicating timing for performing service on the vehicle.

44. The mobile computing device of claim 40, wherein the preferences module provides the communication preferences to the service provider.

45. The mobile computing device of claim 30, wherein the mobile computing device comprises a camera and wherein the vehicle identification module obtains vehicle identification information by capturing a vehicle identification number (VIN) of the vehicle using the camera.

46. The mobile computing device of claim 30, further comprising a vehicle status module for receiving status information of the vehicle.

47. The mobile computing device of claim 46, wherein receiving status information of the vehicle comprises receiving information from a user regarding a service history of the vehicle.

48. The mobile computing device of claim 46, wherein receiving status information of the vehicle comprises receiving a mileage of the vehicle.

49. The mobile computing device of claim 46, wherein the vehicle status module further provides the received status information to the service provider.

50. The mobile computing device of claim 46, wherein the vehicle status module further provides an interface on the mobile computing device allowing a user to enter the status information.

51. The mobile computing device of claim 30, further comprising a confirmation module for confirming to the service provider that the lifecycle message was viewed.
